(19) United States
(12) Patent Application Publication
(10) Pub. No.: US 2025/0082098 A1
(43) Pub. Date: Mar. 13, 2025

(54) Under-Desk Mesh Organizer

(71) Applicant: Fresh Finest LLC, Spring Valley, NY (US)

(72) Inventor: Eliesar Weiss, Spring Valley, NY (US)

(21) Appl. No.: 18/825,915

(22) Filed: Sep. 5, 2024

Related U.S. Application Data
(60) Provisional application No. 63/581,216, filed on Sep. 7, 2023.

(51) Int. Cl. A47B 83/04; B65D 25/08; B65D 25/22; F16B 2/06

(52) U.S. Cl. CPC A47B 83/045; B65D 25/08; B65D 25/22; F16B 2/065; A47B 2200/0085

(57) ABSTRACT

The under-desk mesh organizer is a clip-on steel mesh drawer housing with dual drawers and is a versatile and practical addition to any desk or work surface. The under-desk mesh organizer has a drawer housing and clamps. The drawer housing has a drawers and attachment plates. The drawer housing is designed with a steel material that ensures durability with a lightweight design. The drawer housing has high quality slides that ensures smooth and quiet opening and closing of each of the drawers. The drawers is designed with a steel mesh material that mitigates dust accumulation and provides visibility into the drawers.

### FIELD OF THE INVENTION

The present invention relates generally to desk accessories. More specifically, the present invention is a clip-on steel mesh under-desk drawer with dual drawers.

### BACKGROUND OF THE INVENTION

The modern workplace and home office environments often demand efficient use of space and organization. Traditional desk drawers can be bulky, collect dust, and require complex installation methods. It is an object of the present invention to introduce an innovative solution by providing users with a clip-on steel mesh under-desk drawer with dual drawers, designed to provide a practical, space-saving, and easily installable storage solution that can also serve as a desktop.

### BRIEF DESCRIPTION OF THE DRAWINGS

FIG. 1 is a top front left perspective view of the present invention in an exploded view.

FIG. 2 is a bottom rear right perspective view of the present invention in an exploded view.

FIG. 3 is a top front right view of the present invention in a configured view.

FIG. 4 is a bottom rear left view of the present invention in a configured view.

FIG. 5 is a front view of the present invention.

FIG. 6 is a left side of the present invention secured to a table.

### DETAILED DESCRIPTION OF THE INVENTION

All illustrations of the drawings are for the purpose of describing selected versions of the present invention and are not intended to limit the scope of the present invention.

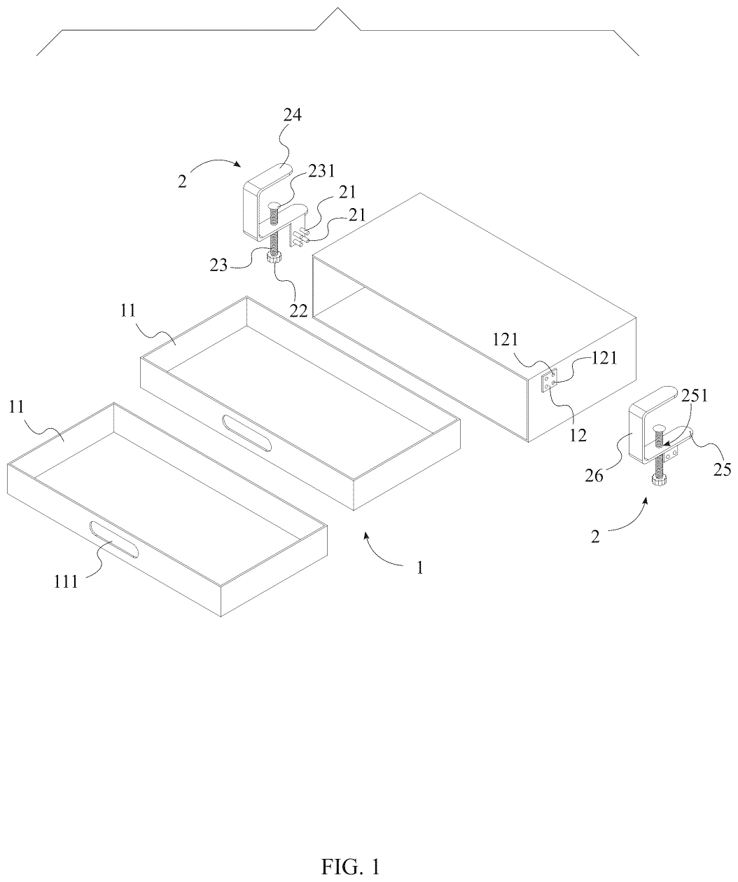

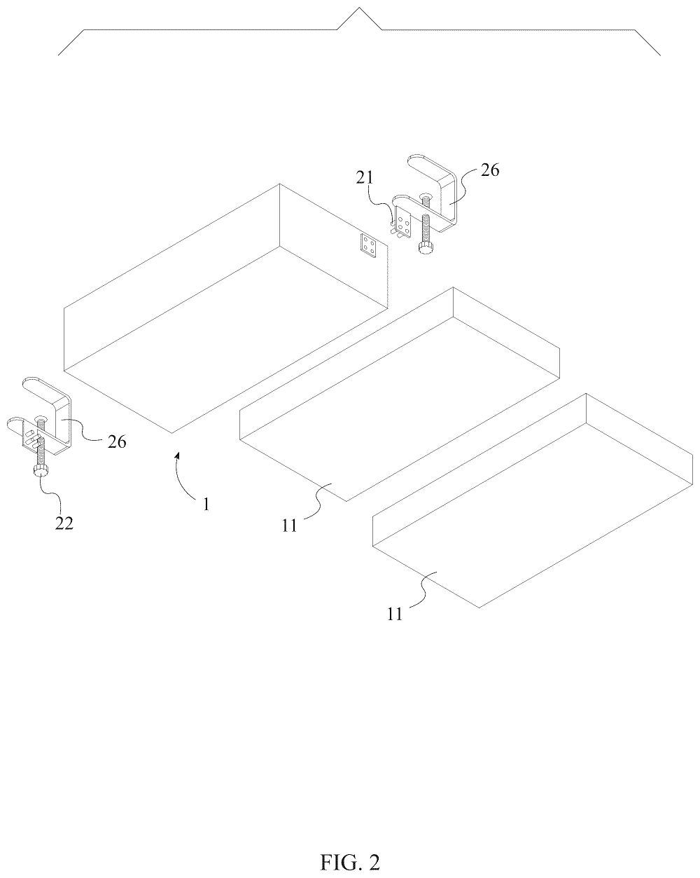

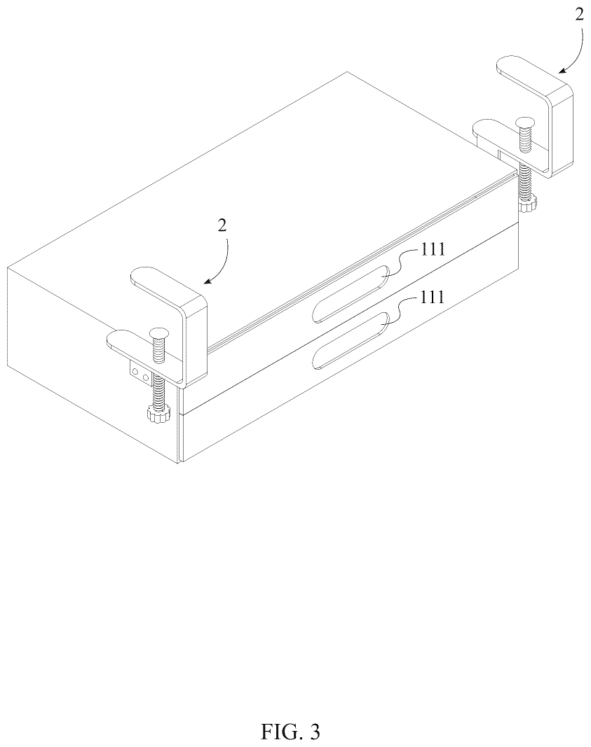

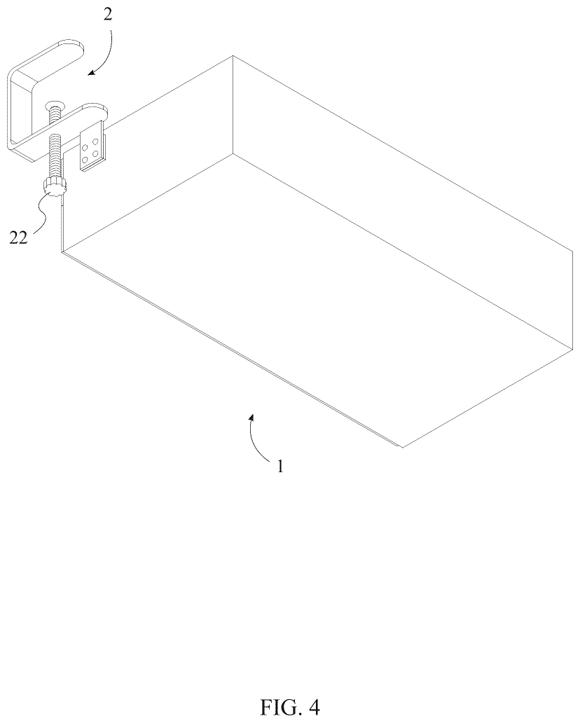

The present invention is a clip-on steel mesh under-desk drawer with dual drawers and is a versatile and practical addition to any desk or work surface as seen in FIG. 1-6. The under-desk mesh organizer comprises a drawer housing 1 and a plurality of clamps 2. The drawer housing 1 comprises a plurality of drawers 11 and a plurality of attachment plates 12. The drawer housing 1 is designed with a steel material that ensures durability with a lightweight design. The drawer housing 1 further comprises high quality slides that ensures smooth and quiet opening and closing of each of the plurality of drawers 11. The plurality of drawers 11 is designed with a steel mesh material that mitigates dust accumulation and provides visibility into the plurality of drawers 11. The plurality of drawers 11 is designed to fit a variety of common office supplies such as pens, notebooks, documents, and electronic devices. Each of the plurality of clamps 2 comprises a plurality of bolts 21, a knob 22, a threaded rod 23, a clamp top surface 24, and a clamp bottom surface 25 shown in FIG. 1. Each of the plurality of drawers 11 comprises a drawer handle 111. Each of the plurality of attachment plates 12 comprises a plurality of holes 121. The threaded rod 23 comprises an attachment end 231. The clamp bottom surface 25 comprises a rod hole 251. Each of the plurality of clamps 2 mechanically couples to the left and right side of the drawer housing 1. As a result, the plurality of clamps 2 holds the drawer housing 1 to a table 3 surface such as a desk.

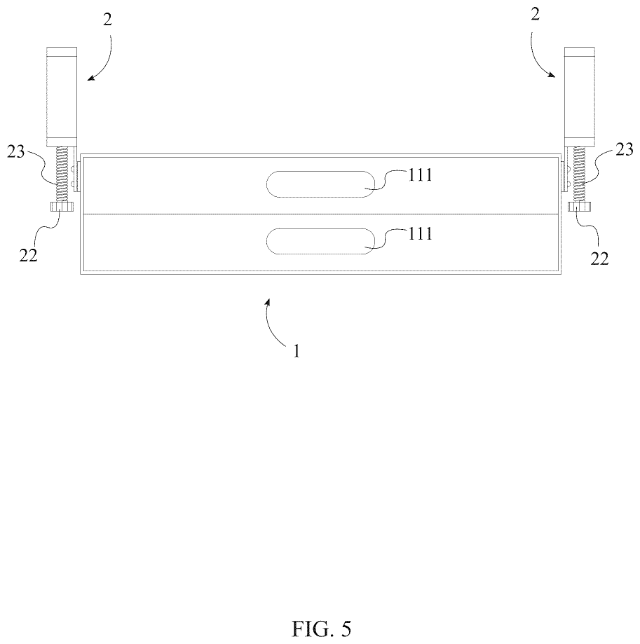

In reference to FIG. 5, the drawer housing 1 is a hollow rectangular shape. Consequently, the drawer housing 1 is shaped to hold the plurality of drawers 11. The drawer housing 1 receives the plurality of drawers 11. Accordingly, the drawer housing 1 holds at least one drawer and may hold a plurality of drawers 11. The plurality of drawers 11 mechanically couples within the drawer housing 1. Thus, each of the plurality of drawers 11 slides in an out of the drawer housing 1 revealing the contents within each of the plurality of drawers 11. The drawer handle 111 integrates along the front side of each of the plurality of drawers 11. So, the drawer handle 111 enables each of the plurality of drawers 11 to be easily opened and closed.

Further, each of the plurality of attachment plates 12 integrates along the left and right side of the drawer housing 1 as shown in FIG. 1. As a result, the plurality of attachment plates 12 enables the plurality of clamps 2 to secure to the drawer housing 1, securing it along a table 3. The plurality of holes 121 traverses through each of the plurality of attachment plates 12. Each of the plurality of holes 121 is a circular shape. Consequently, each of the plurality of holes 121 has a threaded surface that interlocks with each of the plurality of bolts 21, which secures each of the plurality of clamps 2 to the drawer housing 1.

Furthermore, each of the plurality of holes 121 receives each of the plurality of bolts 21 as seen in FIG. 1. Accordingly, each of the plurality of bolts 21 enter each of the plurality of holes 121. The plurality of bolts 21 mechanically couples the plurality of clamps 2 to the drawer housing 1. Thus, the plurality of clamps 2 is secured along the left and right side of the drawer housing 1.

In reference to FIG. 1, the clamp top surface 24 forms a bracket 26 with the clamp bottom surface 25. The bracket 26 is a C-shaped member that encompasses the edge of a table 3 surface such as a desk. The clamp top surface 24 rests along the surface of a table 3. So, the clamp top surface 24 provides a clamping force along the top side of the table 3 wherein the threaded rod 23 provides a clamping force along the bottom side of the table 3.

Further, the rod hole 251 traverses through the clamp bottom surface 25 as shown in FIG. 1. As a result, the rod hole 251 is a circular shaped threaded hole. The rod hole 251 receives the threaded rod 23. Consequently, the threaded rod 23 moves through the rod hole 251 by rotating. The threaded rod 23 is mechanically coupled with the bracket 26. Accordingly, as the threaded rod 23 rotates the attachment end 231 moves up and down, towards and away from the table 3. The threaded rod 23 secures the clamp top surface 24 to the table 3. Thus, each of the plurality of clamps 2 secures the drawer housing 1 to a table 3 surface within the open space of the bracket 26.

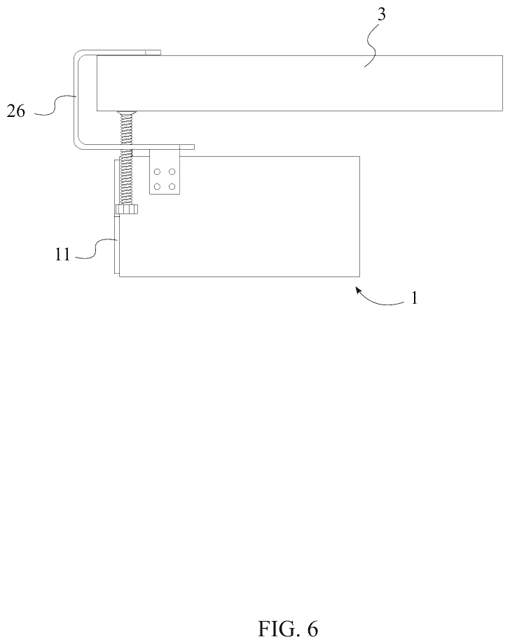

Furthermore, the attachment end 231 is positioned along the threaded rod 23 which extends into the bracket 26 as seen in FIG. 6. The attachment end 231 contacts the underside of a table 3 when the threaded rod 23 is tightened to clamp along the table 3 surface. The knob 22 is positioned along the end of the threaded rod 23 opposite the attachment end 231. The knob 22 is a ribbed member that provides a grip to easily rotate the threaded rod 23 within the rod hole 251. Further, the knob 22 facilitates tightening and loosening of the threaded rod 23. This design allows for the plurality of clamps 2 to tighten and release from around the edge of a table 3, wherein the drawer housing 1 is secured either below or above the table 3 surface.

Although the invention has been explained in relation to its preferred embodiment, it is to be understood that many other possible modifications and variations can be made without departing from the spirit and scope of the invention as hereinafter claimed.

What is claimed is:

1. An under-desk mesh organizer comprising:
a drawer housing;
a plurality of clamps;
the drawer housing comprising a plurality of drawers and a plurality of attachment plates;
each of the plurality of clamps comprising a plurality of bolts, a knob, a threaded rod, a clamp top surface, and a clamp bottom surface;
each of the plurality of drawers comprising a drawer handle;
each of the plurality of attachment plates comprising a plurality of holes;
the threaded rod comprising an attachment end;
the clamp bottom surface comprising a rod hole; and
each of the plurality of clamps mechanically coupling to the left and right side of the drawer housing.

2. The under-desk mesh organizer as claimed in claim 1 comprising:
the drawer housing being a hollow rectangular shape;
the drawer housing receiving the plurality of drawers;
the plurality of drawers mechanically coupling within the drawer housing; and
the drawer handle integrating along the front side of each of the plurality of drawers.

3. The under-desk mesh organizer as claimed in claim 2 comprising:
each of the plurality of attachment plates integrating along the left and right side of the drawer housing;
the plurality of holes traversing through each of the plurality of attachment plates; and
each of the plurality of holes being a circular shape.

4. The under-desk mesh organizer as claimed in claim 3 comprising:
each of the plurality of holes receiving each of the plurality of bolts; and
the plurality of bolts mechanically coupling the plurality of clamps to the drawer housing.

5. The under-desk mesh organizer as claimed in claim 1 comprising:
the clamp top surface forming a bracket with the clamp bottom surface; and
the clamp top surface resting along the surface of a table.

6. The under-desk mesh organizer as claimed in claim 5 comprising:
the rod hole traversing through the clamp bottom surface;
the rod hole receiving the threaded rod;
the threaded rod being mechanically coupled with the bracket; and
the threaded rod securing the clamp top surface to the table.

7. The under-desk mesh organizer as claimed in claim 5 comprising:
the attachment end being positioned along the threaded rod extending into the bracket; and
the knob being positioned along the end of the threaded rod opposite the attachment end.

8. The under-desk mesh organizer as claimed in claim 7 wherein the knob facilitating tightening and loosening of the threaded rod.

9. An under-desk mesh organizer comprising:
a drawer housing;
a plurality of clamps;
the drawer housing comprising a plurality of drawers and a plurality of attachment plates;
each of the plurality of clamps comprising a plurality of bolts, a knob, a threaded rod, a clamp top surface, and a clamp bottom surface;
each of the plurality of drawers comprising a drawer handle;
each of the plurality of attachment plates comprising a plurality of holes;
the threaded rod comprising an attachment end;
the clamp bottom surface comprising a rod hole;
each of the plurality of clamps mechanically coupling to the left and right side of the drawer housing;
the drawer housing being a hollow rectangular shape;
the drawer housing receiving the plurality of drawers;
the plurality of drawers mechanically coupling within the drawer housing; and
the drawer handle integrating along the front side of each of the plurality of drawers.

10. The under-desk mesh organizer as claimed in claim 9 comprising:
each of the plurality of attachment plates integrating along the left and right side of the drawer housing;
the plurality of holes traversing through each of the plurality of attachment plates; and
each of the plurality of holes being a circular shape.

11. The under-desk mesh organizer as claimed in claim 10 comprising:
each of the plurality of holes receiving each of the plurality of bolts; and
the plurality of bolts mechanically coupling the plurality of clamps to the drawer housing.

12. The under-desk mesh organizer as claimed in claim 9 comprising:
the clamp top surface forming a bracket with the clamp bottom surface; and
the clamp top surface resting along the surface of a table.

13. The under-desk mesh organizer as claimed in claim 12 comprising:
the rod hole traversing through the clamp bottom surface;
the rod hole receiving the threaded rod;
the threaded rod being mechanically coupled with the bracket; and
the threaded rod securing the clamp top surface to the table.

14. The under-desk mesh organizer as claimed in claim 12 comprising:
the attachment end being positioned along the threaded rod extending into the bracket; and
the knob being positioned along the end of the threaded rod opposite the attachment end.

15. The under-desk mesh organizer as claimed in claim 14 wherein the knob facilitating tightening and loosening of the threaded rod.

16. An under-desk mesh organizer comprising:
a drawer housing;
a plurality of clamps;
the drawer housing comprising a plurality of drawers and a plurality of attachment plates;
each of the plurality of clamps comprising a plurality of bolts, a knob, a threaded rod, a clamp top surface, and a clamp bottom surface;
each of the plurality of drawers comprising a drawer handle;
each of the plurality of attachment plates comprising a plurality of holes;
the threaded rod comprising an attachment end;
the clamp bottom surface comprising a rod hole;
each of the plurality of clamps mechanically coupling to the left and right side of the drawer housing;
the drawer housing being a hollow rectangular shape;
the drawer housing receiving the plurality of drawers;
the plurality of drawers mechanically coupling within the drawer housing;
the drawer handle integrating along the front side of each of the plurality of drawers;
each of the plurality of attachment plates integrating along the left and right side of the drawer housing;
the plurality of holes traversing through each of the plurality of attachment plates; and
each of the plurality of holes being a circular shape.

17. The under-desk mesh organizer as claimed in claim 16 comprising:
each of the plurality of holes receiving each of the plurality of bolts; and
the plurality of bolts mechanically coupling the plurality of clamps to the drawer housing.

18. The under-desk mesh organizer as claimed in claim 16 comprising:
the clamp top surface forming a bracket with the clamp bottom surface; and
the clamp top surface resting along the surface of a table.

19. The under-desk mesh organizer as claimed in claim 18 comprising:
the rod hole traversing through the clamp bottom surface;
the rod hole receiving the threaded rod;
the threaded rod being mechanically coupled with the bracket; and
the threaded rod securing the clamp top surface to the table.

20. The under-desk mesh organizer as claimed in claim 18 comprising:
the attachment end being positioned along the threaded rod extending into the bracket;
the knob being positioned along the end of the threaded rod opposite the attachment end; and
the knob facilitating tightening and loosening of the threaded rod.
